(19) United States
(12) Patent Application Publication
(10) Pub. No.: US 2002/0102895 A1
(43) Pub. Date: Aug. 1, 2002

(54) Multi-functional knit fabric with enhanced insulating properties

(76) Inventor: William F. Willard, Johnstown, NY (US)

Correspondence Address: SCHMEISER OLSEN & WATTS, 18 E UNIVERSITY DRIVE, SUITE # 101, MESA, AZ, 85201

(21) Appl. No.: 09/771,402

(22) Filed: Jan. 26, 2001

(51) Int. Cl. B32B 5/26

(52) U.S. Cl. 442/244; 442/246; 442/318

(57) ABSTRACT

A fabric for use in outdoor apparel is disclosed comprising an insulating layer including a multitude of cross fibers disposed between exterior fabric layers, the combination of which creates a temperature regulating material suitable for maintaining a comfortable body temperature in environments where the ambient temperature is low. The fabric is created using a double needle bar knitting technique which allows several fiber choices to be incorporated into a single fabric sample and infuses the enclosed, insulating layer with a multitude of air spaces helpful in the insulating process. In addition to air spaces, the invention uses phase change technology in the insulating layer to regulate and stabilize the temperature of the air spaces that exist between the cross fibers, thus producing a thermal regulation effect greater than would be possible if either technology were used alone.

### BACKGROUND OF THE INVENTION

1. Technical Field

This invention generally relates to knitted fabric, and more specifically relates to a multi-layer insulating fabric suitable for use in outdoor apparel.

2. Background Art

The desire to participate in outdoor activities in cold weather has lead to the creation of various forms of insulating apparel. Cold weather clothing generally traps air in pockets to create a buffer between the skin and the cold outside air. Heat that would otherwise pass quickly through a garment's fabric layers and escape is trapped in these air spaces, thus helping to maintain a more stable temperature in the fabric's vicinity. The thicker this buffer zone is, the more air spaces it contains and the better it insulates. However, thick insulating layers in outdoor wear leads to bulky, awkward apparel that can severely restrict one's freedom of movement.

Trapped air insulation is used, among other places, in a construction known as a spacer fabric. Spacer fabrics have two exterior faces between which are a multitude of cross fibers interknitted with and connecting the exterior faces but maintaining a space between them. This construction creates air pockets among the cross fibers and between the two faces. The air trapped in the air pockets has an insulating effect. Because of the way the two faces are held apart by the cross fibers, spacer fabrics have good shock absorbing properties in addition to their insulating effects. As with any trapped air insulation, however, better temperature protection requires thicker, heavier, and bulkier fabric. Although typical spacer fabrics can be manufactured as thick as 30 millimeters, outdoor apparel of that thickness is somewhat impractical. A further problem with trapped air insulation is its inability to adjust with changes in activity level. Heightened activity leads to overheating and excess perspiration, while inactive periods are characterized by an equally uncomfortable lack of warmth brought on by the presence of the retained perspiration.

Phase change materials have been developed in an attempt to overcome the problem of bulkiness and excessive clothing weight. These materials absorb and release heat without changing temperature, thus providing for the adjustment and actual regulation of temperature within a certain operating range. This ability to store up excess heat to be released when needed represents an advance over the less sophisticated temperature maintenance properties of trapped air.

Current thermal regulation materials and fabrics do not offer a satisfactory solution to the need for a versatile garment. Existing thermal insulating fabrics do not address the need to adopt to temperature variations. This failure restricts the amount of time a wearer of such fabric can comfortably remain in a low temperature environment, and limits the temperature range within which such comfort may be maintained.

### SUMMARY OF INVENTION

In order to fully appreciate the subject invention, the following terms as used in this application are thus defined:

1. spacer fabric is a multi-layer fabric having at least three layers, including an upper layer, a lower layer, and a middle layer wherein fibers of the middle layer are interknitted or otherwise connected with the upper and lower layers.

2. double needled bar is a knitting process used to create a multi-layer fabric which has at least three layers, incorporates multiple fabrics and is produced in a single operation resulting in a unitary construction.

3. cross fibers are fibers that span the distance between and are connected to or intragal with upper and lower fabric layers.

According to the present invention, a fabric adapted for use in outdoor apparel is provided comprising an insulating layer consisting of a multitude of cross fibers disposed between exterior fabric layers, creating a temperature regulating material suitable for maintaining a comfortable body temperature in environments where the ambient temperature is low. The fabric may be created using a double needle bar knitting technique which allows several fiber choices to be incorporated into a single fabric sample and infuses the enclosed, insulating layer with a multitude of air spaces helpful in the insulating process. The phase change technology in the insulating layer regulates and stabilizes the temperature of the air spaces that exist between the cross fibers.

An advantage of the fabric of the present invention is that it provides greater temperature regulation than existing fabrics, allowing a user to remain comfortable over a wider temperature range than is possible with existing fabrics and to maintain that comfort level over a longer period of time. Each layer of the fabric of the present invention may be knit together by one machine in one operation, a cost-effective way to produce a product that addresses several different qualities needed in outdoor apparel. This method of manufacture allows the customization of the fabric's features through the selection and incorporation of particular fibers into its construction. A further advantage of the present invention is that its layered construction lowers manufacturing costs while providing the ease of cutting and sewing a single knitted fabric.

The cross fibers of a spacer fabric material must be of sufficient rigidity or have a sturdy enough structure so as to span the distance between the upper and lower fabric layers and maintain those layers in a sufficiently spaced apart relationship. In this regard, a monofilament which, due to its single strand nature, is generally not used in typical insulated apparel, since it does not have the typical soft and fuzzy feel that such materials generally require. Accordingly the monofilament, while it would not generally be used in insulating fabric, works in the subject application because it has a structure which is sufficiently sturdy to hold the upper and lower layers apart. This may be contrasted to a material such as a spun fiber of a yarn, which would not work in this capacity due to the fact that it is not sturdy but has more of a limp characteristic which is insufficient to hold the layers apart with a substantially uniform space between the layers as may be accomplished with the monofilament.

Having thus created the spacer fabric, in order to obtain some of the desired results of the subject invention, the monofilament must contain phase change materials which gives it the property of holding and releasing heat as needed to maintain the atmosphere between the upper and lower layers at a relatively constant temperature. Thus the subject invention goes against normal teachings by using a monofilament within an insulating material but then adds a phase change material to enable the monofilament to function within the apparel in a way that is more desirable than either the use of typical insulating material or the use of a spacer fabric.

By combining a double bar knit spacer fabric with a monofilament and phase change material, a much improved insulator is created in a garment being more than 15 denier with the ability to increase the denier rating and the insulating capability by increase in the air spaces and the phase change materials to what ever levels are appropriate given the type of garment being created.

The foregoing and other features and advantages of the invention will be apparent from the following more particular description of embodiments of the invention, and as illustrated in the accompanying drawings.

### BRIEF DESCRIPTION OF DRAWINGS

The preferred embodiments of the present invention will hereinafter be described in conjunction with the appended drawings, where like designations denote like elements.

FIG. 1 is a cross-sectional view of the fabric of the present invention.

FIG. 2 is a three-dimensional perspective view of an enclosed layer of the invention showing the thermal regulation mechanism.

### DETAILED DESCRIPTION OF THE EMBODIMENTS

According to the present invention, a fabric adapted for use in outdoor apparel is provided comprising an insulating layer including a multitude of cross fibers disposed between exterior fabric layers, the combination of which creates a temperature regulating material suitable for maintaining a comfortable body temperature in environments where the ambient temperature is low. The fabric is created using a double needle bar knitting technique which allows several fiber choices to be incorporated into a single fabric sample and infuses the enclosed, insulating layer with a multitude of air spaces helpful in the insulating process. In addition to air spaces, the invention uses phase change technology in the insulating layer to regulate and stabilize the temperature of the air spaces that exist between the cross fibers, thus producing a thermal regulation effect that would not be possible if either technology were used alone.

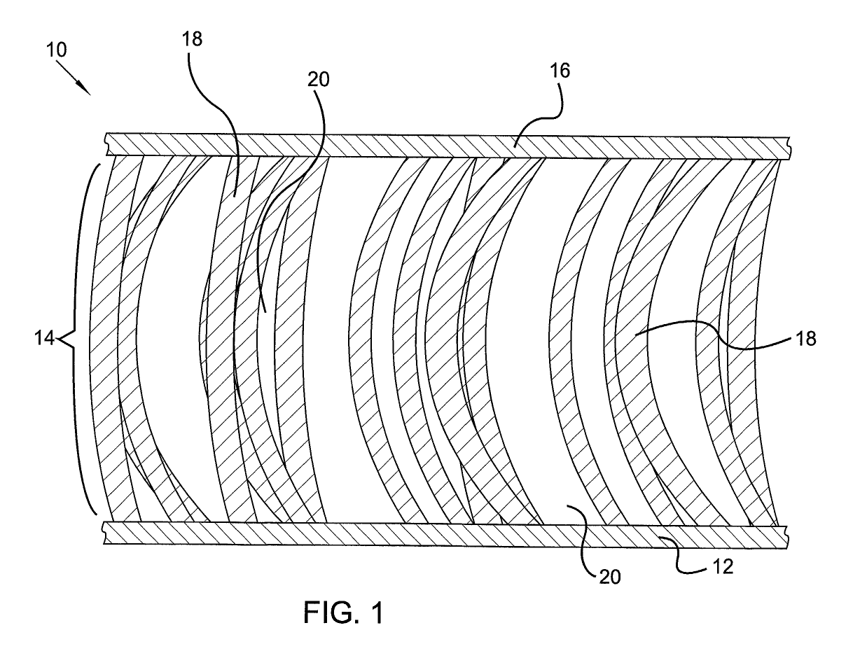

Referring now to the figures, and in particular to FIG. 1, a thermal regulating fabric 10 comprises a lower layer 12, an enclosed layer 14, and an upper layer 16. The layers are knitted together forming what is known as a spacer fabric. Each layer may be manufactured to possess various qualities useful in outdoor apparel. In a first embodiment, lower layer 12 is a wicking fiber, enclosed layer 14 is an insulating layer, and upper layer 16 is an abrasion-resistant fiber.

Knitted fabrics are constructed by intertwining yam or thread in a series of connected loops with each row of loops caught into the preceding row. A person knitting by hand builds up a row one loop at a time. Knitting machines capable of completing an entire row of loops at once have greatly increased the speed with which knitted textile products may be produced. Knits can be divided into two basic types called weft knits and warp knits. Each type includes various subtypes, one of which, a subtype of warp knit called a raschel knit, is important in the production of the present invention and will now be further described.

Raschel knits incorporate yarns of differing thicknesses into an open, lacelike fabric where a heavy, textured yam is held in place by a much finer yam. This combination of yams can be manipulated into a wide range of textures from fragile to coarse. Like all warp knits, a raschel knit is produced only by machine, where each length of yarn is controlled by a separate needle, causing the loops to interlock along the length of the fabric.

The double needle bar knitting technique is often used in conjunction with a raschel knit. In this context, the technique employs two independently operated needle bars supplied with multiple lengths of yarn to produce what is called a spacer fabric. Spacer fabrics have two exterior layers held together by an enclosed layer of traversing yarns or cross fibers interknitted into each of the exterior layers. These cross fibers have traditionally been made almost exclusively of polyester monofilament. Because spacer fabrics are primarily used for shock absorption, the cross fibers have generally been rather thick-30 and 70 denier fibers have been typical-in order to resist crushing. A denier is a unit of fineness for fibers based on a standard mass per length of one gram per 9,000 meters of yarn.

Fabric 10 may be created using the double needle bar technique. The independently operated needle bars are fed with multiple warps of yarn from a plurality of respective warp beams through a corresponding plurality of yarn guide bars. Because the various yarn guide bars can feed different types of yarn to different individual needles, multiple layers of fabric, each with different qualities, may be formed simultaneously. Thus a single machine in a single knitting process may produce a single fabric that possesses multiple properties desirable in outdoor apparel.

In the first embodiment spoken of, for example, lower layer 12 is produced from fiber suitable for wicking moisture away from a person's skin. The term “wicking” in this context refers to the transfer of moisture away from the skin to an outer layer of material where the moisture can more quickly evaporate. One method of producing a wicking effect is to incorporate hydrophobic and hydrophilic yarns into a fabric in such a way that the hydrophobic yarn is adjacent to the area from which moisture is to be removed and the hydrophilic yam is in an area from which the moisture can easily evaporate or in which its presence will not cause discomfort. The hydrophobic layer wicks moisture towards the hydrophilic yam, which continues to draw the moisture away from the area where it is not wanted, thus producing a microclimate that is dry and comfortable.

Upper layer 16 may be an abrasion-resistant fiber. In another embodiment it may be a water-resistant or a stain-resistant layer. These and other qualities may be achieved through a proper selection of the fiber that goes into the production of upper layer 16. Both upper layer 16 and lower layer 12 comprise fibers that are knit together to form a fabric possessing various qualities such as the ones spoken of. The knitting process thus proceeds on multiple levels simultaneously, where fibers are knitted into fabric layers while fabric layers are joined in a further knitting process to create the multi-layered fabric known as spacer fabric.

Enclosed layer 14 comprises a multitude of cross fibers 18, so named because they lie substantially at right angles to the substantially parallel planes occupied by lower layer 12 and upper layer 16, and a multitude of air spaces interspersed among the cross fibers. It should be understood that although cross fibers 18 connect with and are interknitted into both lower layer 12 and upper layer 16, meaning their general direction is perpendicular to the plane of the other two layers, cross fibers 18 do not in general follow a straight path as they travel between them. The perpendicularity of enclosed layer 14 with respect to both lower layer 12 and upper layer 16 is meant in a general sense. In other words, taken together, cross fibers 18 are, in general, substantially perpendicular to lower layer 12 and upper layer 16.

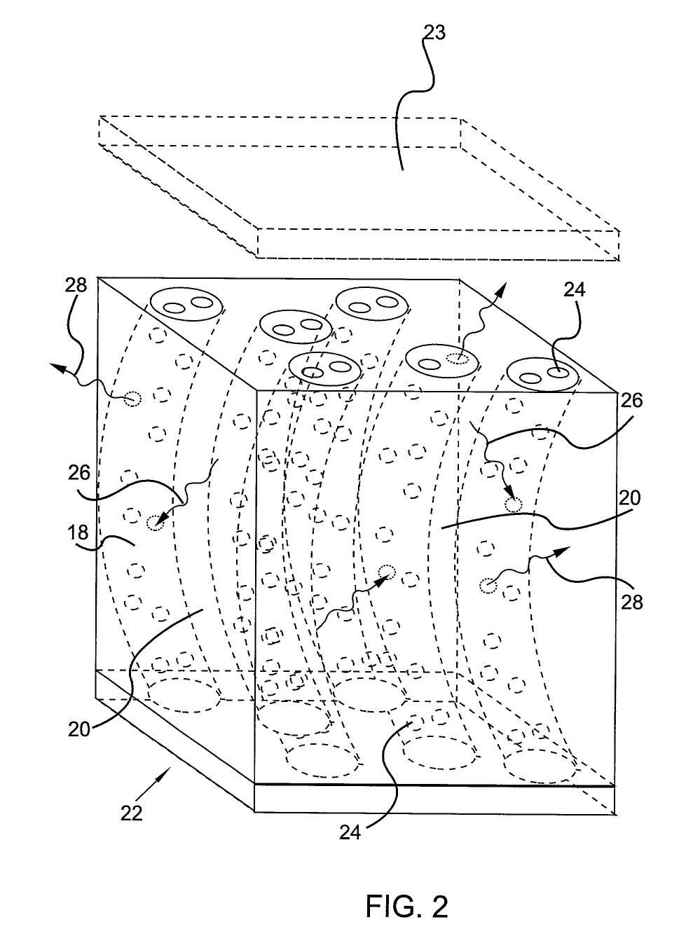

In addition to cross fibers 18, enclosed layer 14 also includes air spaces 20. Air spaces 20 are spread randomly throughout enclosed layer 14, and are of random shape and volume. They surround and are surrounded by cross fibers 18. The insulating properties of enclosed layer 14 will be more fully explained in connection with FIG. 2.

Referring now to FIG. 2, a vertical slice 22 of thermal regulating fabric 10 from FIG. 1 contains cross fibers 18 and air spaces 20. For clarity, a segment 23 of upper layer 16 is shown above vertical slice 22 and displaced from it. Cross fibers 18 contain phase change capsules 24. Phase change materials (PCMs), such as the material contained within phase change capsules 24, are produced by various manufacturers, notably Outlast Technologies, Inc. PCMs regulate the temperature in a surrounding region by absorbing and releasing heat, or thermal energy, without changing temperature. This is possible because within the operating temperature range the total available thermal energy is used up in producing the phase change itself, with nothing left over to cause a temperature shift.

Outlast® PCMs are composed of a substance that exists in a mixed state at the boundary between the substance's liquid and solid phases, where a phase change has begun but is not complete and where characteristics of both phases are present. PCMs are calibrated to stabilize in a half liquid, half solid state within a temperature range slightly below a comfortable skin temperature. As a person's body generates heat from increased activity levels the solid component of the PCM absorbs and stores that heat, causing a transition to liquid form. After the body's heat production stops the liquid begins to turn solid again, releasing its stored heat in the process. The entire scenario is played out at a substantially constant temperature. PCMs manufactured by other companies work on the same general principle. The above discussion should not be understood to limit the PCMs used in conjunction with the present invention to those made by a particular manufacturer or company.

The previous paragraph outlined the basics of PCM function. In the subject invention PCMs are incorporated into fibers used in a spacer fabric thus changing the process of heat transfer as will now be described. Heated air generated by the body's exertion is first trapped in air spaces 20 located among cross fibers 18. This trapped hot air then heats phase change capsules 24, causing the solid portion of capsules 24 to begin a transition to liquid form as described above. When a person's body, because of inactivity, stops generating heat, the process is reversed: capsules 24 begin to release their stored heat into air spaces 20 surrounding cross fibers 18, dramatically slowing the temperature change experienced by air spaces 20 and creating a microclimate with a near constant temperature. By regulating the temperature of already trapped, self-contained air, rather than directing released energy directly back to the body, the fabric of this invention provides a significant benefit over existing thermal regulation fabrics and materials.

Referring still to FIG. 2, absorbed energy vectors 26 represent thermal energy flowing from air spaces 20 into phase change capsules 24 contained in cross fibers 18. Released energy vectors 28 represent thermal energy flowing in the other direction, from phase change capsules 24 to air spaces 20. This exchange of energy is what regulates and stabilizes the temperature in the microclimate existing between thermal regulating fabric 10 and the portion of a wearer's body covered by it.

For reasons explained below, the cross fibers would generally not be fabricated from acrylic but could likely be polypropylene, polyester or other material suitable to be formed as a monofilament and able to accept phase change material.

Outlast® acrylic PCM fibers are currently offered in 2.2, 3.2, and 5 denier thicknesses, which are fairly thin and flexible spacer fabrics, which primarily have been used for shock absorption and need stiff cross fibers to maintain good layer separation, have preferentially been manufactured using rather thick cross fibers, typically 30 or 70 denier. Yet yarns and fibers that achieve suitable thickness by virtue of combining many filaments spun together are not as stiff as those of comparable size made of a single filament. To be most effective, therefore, a spacer fabric should incorporate thick cross fibers made from a single filament. Polyester monofilament, having both of these qualities, is ideal, and is the normal material used for the cross fibers in a spacer fabric, and polyester monofilament infused with phase change capsules is a possible material for the spacer fabric contemplated herein.

From the foregoing description it will be apparent that a fabric with enhanced thermal regulatory properties has been provided wherein an insulating layer includes a multitude of cross fibers disposed between upper and lower fabric layers, the combination of which creates a temperature regulating material suitable for maintaining a comfortable body temperature in environments where the ambient temperature is low. The fabric is created using a double needle bar knitting technique which allows several fiber choices to be incorporated into a single fabric sample and infuses the enclosed, insulating layer with a multitude of air spaces helpful in the insulating process. The fabric incorporates phase change materials in the insulating layer to regulate and stabilize the temperature of the air spaces that exist between the cross fibers, thus producing a beneficial thermal regulation effect that was not previously possible.

While the invention has been particularly shown and described with reference to preferred embodiments thereof, it will be understood by those skilled in the art that various changes in form and details may be made therein without departing from the spirit and scope of the invention.

I claim:

1. A temperature regulating fabric comprising an upper layer, an enclosed layer, and a lower layer, said enclosed layer including a plurality of interspersed cross fibers and air spaces, said enclosed cross fibers being connected to with said upper layer and said lower layer, said enclosed cross fibers containing phase change materials embedded therein.

2. The fabric of claim 1 where said phase change materials permit the bidirectional flow of thermal energy between the air in said air spaces and said phase change materials.

3. The fabric of claim 1 where said lower layer comprises a wicking fiber.

4. The fabric of claim 1 where said upper layer comprises an abrasion-resistant exterior fiber.

5. The fabric of claim 1 where said cross fibers comprise an acrylic fiber.

6. The fabric of claim 1 where said cross fibers comprise a polyester fiber

7. The fabric of claim 1 where said cross fibers comprise a polypropylene fiber.

8. The fabric of claim 1 where said cross fibers comprise a nylon fiber.

9. The fabric of claim 1 where said cross fibers comprise a pre-manufactured material.

10. The fabric of claim 1 where said upper, enclosed, and lower layers are knit together by a single machine in a single operation.

11. The fabric of claim 10 where said knitting operation is a double needle bar construction.

12. A temperature regulating fabric comprising an upper layer, an enclosed layer, and a lower layer, said enclosed layer including a plurality of interspersed cross fibers and air spaces, said cross fibers forming a pre-manufactured acrylic, polyester, or polypropylene yam containing a multitude of phase change materials embedded therein, said cross fibers being interknitted with said upper layer and said lower layer in a double needle bar knitting operation.

13. The fiber of claim 12 where said cross fibers are formed substantially perpendicularly to said upper and lower layers.

14. The fiber of claim 12 where said upper, enclosed, and lower layers are knit together by a single machine in a single operation.

15. A method of manufacturing a temperature regulating fabric comprising the steps of:
(a) providing a fiber with a multitude of embedded phase change capsules;
(b) forming an upper layer, an enclosed layer, and a lower layer of said fabric;
(c) forming said enclosed layer of said fabric by interknitting said fiber provided with phase change capsules with said upper layer and said lower layer, introducing a multitude of air spaces into said enclosed layer thereby.
